(19) United States
(12) Patent Application Publication
(10) Pub. No.: US 2025/0159112 A1
(43) Pub. Date: May 15, 2025

(54) Automatic or Manual Event Photography System and Method

(71) Applicant: Nicholas Dimatteo, III, Flower Mound, TX (US)

(72) Inventor: Nicholas Dimatteo, III, Flower Mound, TX (US)

(21) Appl. No.: 18/772,529

(22) Filed: Jul. 15, 2024

Related U.S. Application Data
(60) Provisional application No. 63/548,001, filed on Nov. 10, 2023.

(51) Int. Cl. H04N 7/18; A63F 13/213; G06Q 30/0241; H04N 23/66

(52) U.S. Cl. CPC H04N 7/188; A63F 13/213; G06Q 30/0276; H04N 7/183; H04N 23/66

(57) ABSTRACT

An event photography system and method for capturing images of individuals during events. The system includes a camera, in alternative embodiments, a sensor, a control unit, and a memory unit comprising cloud computing and storage as well as hardware for executing software instructions and capturing images. The system can be used in various settings such as FEC's, LBE, casinos, amusement parks, carnivals, fairs, bars, and other events where individuals may win prizes, participate in games, or have a manual activated event. At a venue, the camera is positioned in a location or at or within a game or game machine that captures images of individuals during the event or during a play. A sensor, trigger, or timing detects when an event within the game or activity has occurred, such as a prize being awarded, button being pressed, game being won, or after a period of time.

### FEDERALLY SPONSORED RESEARCH

Not Applicable

### SEQUENCE LISTING OR PROGRAM

Not Applicable

### TECHNICAL FIELD OF THE INVENTION

The present invention relates generally to a system and method for capturing images of individuals during events. More specifically, the present invention relates to a system and method for capturing images of individuals during events, particularly when they win a prize or when an event is triggered.

### BACKGROUND OF THE INVENTION

An on-ride camera is a camera mounted alongside the track of a roller coaster, log flume or other thrill ride that automatically photographs all of the riders on each passing vehicle. They are often mounted at the most intense or fastest part of the ride, resulting in humorously distorted expressions due to fear or wind resistance. The pictures are then available for viewing and purchase as a souvenir.

Typically, upon exiting the ride, park guests pass a booth or shop where their vehicle's pictures are on display screens. Depending on the size of the vehicle used by the attraction, the entire car or groups of one, two, or four may comprise one photograph. The display images are numbered, and customers wishing to purchase a photo take the appropriate number to a cashier.

This photo shop may be located in the same building as the displays or in a separate shop nearby. Many parks offer minimal editing tools (such as red-eye effect removal) before purchase.

The photo is usually ready within minutes of purchase. Single prints in varying sizes are available, provided in cardboard folio bearing the name of the park or ride. Often specialty products, such as posters, keychains or t-shirts, are available also.

A relatively new trend in the industry is on-ride video cameras. On some rides, on-ride videos are recorded by cameras mounted alongside the track, similar to on-ride photo cameras. This provides a third person montage-style of cuts which show the train entering, passing through and then leaving the frame.

Using the alternate system, videos are recorded by cameras mounted inside the ride vehicles, usually on the back of the seat in front of the subject. This provides a first-person stream of consciousness-style film, showing the riders' emotions close up from start to finish.

While taking photos of amusement park riders is known in the prior art, this type of emotional image or video capture has not be adapted to entertainment venues or related events.

Therefore, what is needed is an invention that teaches an event photography system and method for capturing images of individuals during events or other non-rider entertainment activities.

Additionally, what is needed is a system that can be used in various settings such as FEC's (family entertainment centers), LBE (location based entertainment), casinos, amusement parks, carnivals, fairs, bars, and other events where individuals may win prizes, participate in games, or have a manual activated event.

### SUMMARY OF THE INVENTION

The present invention is an event photography system and method for capturing images of individuals during events. The system includes a camera, in alternative embodiments, a sensor, a control unit, and a memory unit comprising cloud computing and storage as well as hardware for executing software instructions and capturing images.

The system can be used in various settings such as FEC's (family entertainment centers), LBE (location based entertainment), casinos, amusement parks, carnivals, fairs, bars, and other events where individuals may win prizes, participate in games, or have a manual activated event.

At a venue, the camera is positioned in a location or at or within a game or game machine that captures images of individuals during the event or during a play. A sensor, trigger, or timing detects when an event within the game or activity has occurred, such as a prize being awarded, button being pressed, game being won, or after a period of time.

The control unit is wired or wirelessly connected to the sensor and the camera. The control unit is configured to receive signals from the sensor when the event trigger occurs. The control unit then activates the camera to capture an image of the individual(s) who triggered the event. The image is then stored in the memory unit locally or as part of a cloud computing system providing remote storage.

### BRIEF DESCRIPTION OF THE DRAWINGS

The accompanying drawings, which are incorporated herein a form a part of the specification, illustrate the present invention and, together with the description, further serve to explain the principles of the invention and to enable a person skilled in the pertinent art to make and use the invention.

FIG. 1 illustrates the system taught by the present invention.

FIG. 2 illustrates one method enabled by the system of the present invention.

FIG. 3 illustrates one method enabled by the system of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized, and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

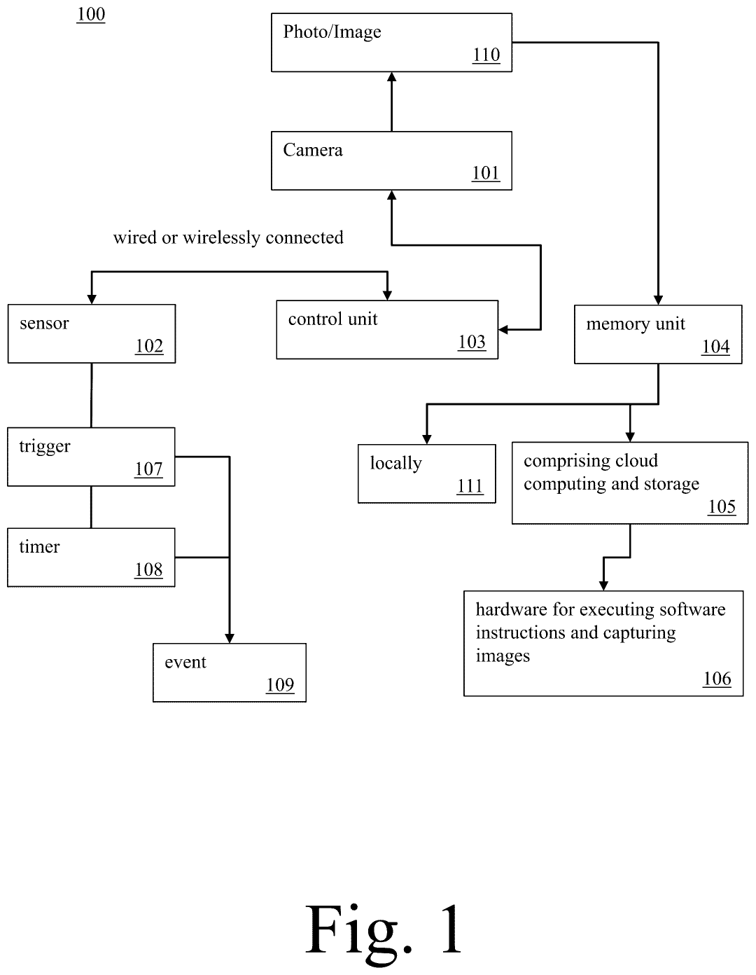

Now referring to the Figures, the present invention is an event photography system and method for capturing images of individuals during events 100. The system, as illustrated in FIG. 1, includes a camera 101, in alternative embodiments, a sensor 102, a control unit 103, and a memory unit 104 comprising cloud computing and storage 105 as well as hardware for executing software instructions and capturing images 106.

At a venue, the camera 101 is positioned in a location or at or within a game or game machine that captures images of individuals during the event or during a play. A sensor 102, trigger 107, or timer 108 detects when an event 109 within the game or activity has occurred, such as a prize being awarded, button being pressed, game being won, or after a period of time.

The control unit 103 is wired or wirelessly connected to the sensor 102 and the camera 101. The control unit 103 is configured to receive signals from the sensor 102 when the event 109 trigger occurs. The control unit 103 then activates the camera 101 to capture an image 110 of the individual(s) who triggered the event 109. The image 110 is then stored in the memory unit 104 locally 111 or as part of a cloud computing system 105 providing remote storage.

The event photography system and method for capturing images of individuals during events 100 can be used in various settings such as FEC's (family entertainment centers), LBE (location based entertainment), casinos, amusement parks, carnivals, fairs, bars, and other events where individuals may win prizes, participate in games, or have a manual activated event.

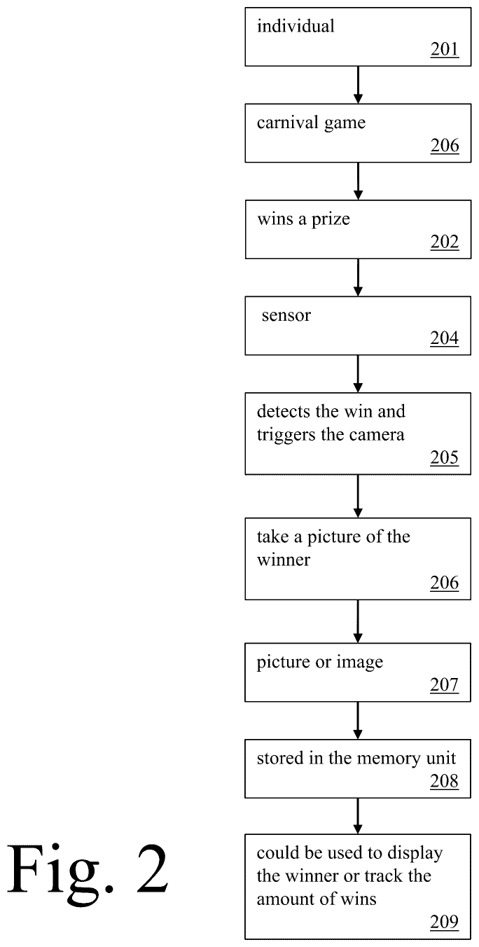

In one exemplary embodiment illustrated in FIG. 2, if an individual 201 wins a prize 202 at a carnival game 206, a sensor 204 detects the win and triggers the camera 205 to take a picture of the winner 206. The picture or image 207 would then be stored in the memory unit 208 and could be used to display the winner or track the amount of wins 209.

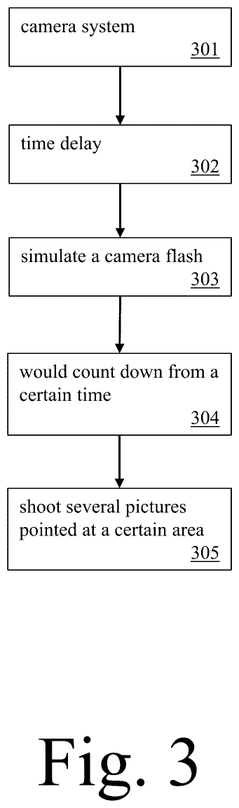

In a first alternative embodiment illustrated in FIG. 3, the camera system 301 would be on a time delay 302 and coupled with flashing lights to simulate a camera flash 303. The camera system 301 would count down from a certain time 304 and shoot several pictures pointed at a certain area 305.

For example, after 10 seconds area X is photographed 10× (ten times) in 30 seconds from multiple cameras. After the pictures are taken they are displayed on a sizzle screen for guests to see and help stir interaction in the group. These pictures can be offered at no price or at an up charge to the individuals in the group.

In a second alternative embodiment, after the camera system takes a picture or series of pictures the guest has an option to scan a QR or link to access the pictures. These will enable long term tracking of the individual as they interact with this system in different parts of the country.

In another exemplary embodiment, the system can also be used for marketing purposes. In this exemplary embodiment, a company could sponsor an event and have their logo displayed on the image captured by the camera. The company could then provide the image to the individual as a promotional item or use the image in their marketing materials.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. An event photography system, comprising:
a camera;
a control unit, and
a memory unit comprising cloud computing and storage as well as hardware for executing software instructions and capturing images.

2. The system of claim 1, wherein
the event photography can be executed manually.

3. The system of claim 1, further comprising
a sensor; and
the event photography is executed automatically by the control unit receiving input from the sensor.

4. The system of claim 3, wherein
at a venue, the camera is positioned in a location or at or within a game or game machine that captures images of individuals during the event or during a play.

5. The system of claim 4, wherein
a sensor, trigger, or timing detects when an event within the game or activity has occurred;
the camera system is on a time delay and coupled with flashing lights to simulate a camera flash;
the camera system counts down from a certain time and shoot several pictures pointed at a certain area;
after the pictures are taken they are displayed on a sizzle screen for guests to see and help stir interaction in the group; and
these pictures can be offered at no price or at an up charge to the individuals in the group.

6. The system of claim 5, wherein
an event within a game or activity includes:
a prize being awarded,
a button being pressed,
a game being won, or
after a period of time.

7. The system of claim 5, wherein
the control unit is wired or wirelessly connected to the sensor and the camera;
the control unit is configured to receive signals from the sensor when an event trigger occurs;
the control unit activates the camera to capture an image of the individual(s) who triggered the event.

8. The system of claim 7, wherein
the image is stored in the memory unit locally or as part of a cloud computing system providing remote storage; and
after the camera system takes a picture or series of pictures the guest has an option to scan a QR or link to access the pictures enabling long term tracking of the individual as they interact with this system in different parts of the country.

9. The system of claim 1, wherein
the system can be used in various settings such as:
FEC's (family entertainment centers),
LBE (location based entertainment),
casinos,
amusement parks,
carnivals,
fairs,
bars, and
other events where individuals may win prizes, participate in games, or have a manual activated event.

10. A method for delivering event photography, comprising the steps of:
positioning a camera, at a venue, in a location, or at or within a game or game machine that captures images of individuals during the event or during a play;
connecting a control unit, wired or wirelessly, to a sensor and a camera;
providing a memory unit comprising cloud computing and storage as well as hardware for executing software instructions and capturing images;
configuring a control unit to receive signals from the sensor when an event trigger occurs;
activating the camera by the control unit to capture an image of the individual(s) who triggered the event.

11. The method of claim 10, further comprising the steps of
detecting when an event within the game or activity has occurred by the sensor, trigger, or timing within the control unit detects; and
executing the event photography automatically by the control unit receiving input from the sensor.

12. The method of claim 10, further comprising the step of
storing the image in the memory unit locally or as part of a cloud computing system providing remote storage; and
after the camera system takes a picture or series of pictures the guest has an option to scan a QR or link to access the pictures enabling long term tracking of the individual as they interact with this system in different parts of the country.

13. The method of claim 10, further comprising the steps of
detecting, by the sensor, if an individual wins a prize at a carnival game;
triggering the camera to take a picture of the winner; and
storing the picture in the memory unit.

14. The method of claim 13, further comprising the steps of
displaying the stored picture of the winner on a display either locally or externally to the event location; and
tracking the amount of wins by a player/winner.

15. The method of claim 13, further comprising the steps of
using the stored picture of the winner for marketing purposes.

16. The method of claim 15, further comprising the steps of
combining a company sponsor of an event with the captured image; and
have a company sponsored logo or other artwork displayed on the image captured by the camera.

17. The method of claim 16, further comprising the steps of
providing the image to the individual as a promotional item or use the image in their marketing materials.

18. The method of claim 10, comprising the step of
manually executing the event photography.

19. The method of claim 10, wherein
an event or triggering event within a game or activity includes:
a prize being awarded,
a button being pressed,
a game being won, or
after a period of time.

20. The method of claim 10, wherein
the camera system is on a time delay and coupled with flashing lights to simulate a camera flash;
the camera system counts down from a certain time and shoot several pictures pointed at a certain area;
after the pictures are taken they are displayed on a sizzle screen for guests to see and help stir interaction in the group; and
these pictures can be offered at no price or at an up charge to the individuals in the group.
